(19) United States
(12) Patent Application Publication
(10) Pub. No.: US 2025/0233940 A1
(43) Pub. Date: Jul. 17, 2025

(54) CHARACTER COMMUNICATION SYSTEM, NON-TRANSITORY COMPUTER-READABLE RECORDING MEDIUM, AND CHARACTER COMMUNICATION METHOD

(71) Applicant: Anaguma Inc., Tokyo (JP)

(72) Inventor: Masaki Nishimura, Tokyo (JP)

(73) Assignee: Anaguma Inc., Tokyo (JP)

(21) Appl. No.: 19/098,148

(22) Filed: Apr. 2, 2025

Related U.S. Application Data
(63) Continuation of application No. PCT/JP2023/025910, filed on Jul. 13, 2023.

(30) Foreign Application Priority Data
Oct. 5, 2022 (JP) 2022-161001

(51) Int. Cl. H04M 1/72469; G06F 3/16

(52) U.S. Cl. CPC H04M 1/72469; G06F 3/165; G06F 3/167

(57) ABSTRACT

A character communication system includes a memory and a processor. The processor switches, when pressing of a first button is detected, from a predetermined screen of a first portable terminal to a first screen including a first input region and a first display region and displays the first screen on the first portable terminal, displays, on a second portable terminal, an incoming call screen including a second button, switches the incoming call screen to a second screen including a second input region and a second display region when pressing of the second button is detected, and displays a character input to the first input region in the second display region by overwriting when the character is input to the first input region, and displays a character input to the second input region in the first display region by overwriting when the character is input to the second input region.

### CROSS-REFERENCE TO RELATED APPLICATION

This application is a continuation application of International Application PCT/JP2023/025910 filed on Jul. 13, 2023 and designated the U.S., which claims the benefits of priorities of Japanese Patent Application No. 2022-161001 filed on Oct. 5, 2022, the entire contents of which are incorporated herein by reference.

### FIELD

The present disclosure relates to a character communication system, a non-transitory computer-readable recording medium, and a character communication method.

### BACKGROUND

In recent years, when mobile phones and smart phones have become widespread, voice communication in places where talking is prohibited, such as inside a train or a bus, has become a problem. While voice communication in a place where a call is prohibited is a problem, there is a demand for real-time communication regardless of the surrounding conditions.

In response to such a demand, a communication terminal device capable of communicating with a telephone terminal in real time regardless of the surrounding conditions has been proposed. The communication terminal device is a terminal capable of communicating with a voice terminal via a telephone network, and is provided with an input means for inputting text data, and a voice synthesis means for converting the text data into a voice signal by voice synthesis. The communication terminal device further includes a transmission means for transmitting the voice signal to the voice terminal, and a reception means for receiving the voice signal from the voice terminal. The communication terminal device further includes a voice recognition means for converting the voice signal from the voice terminal into the text data by voice recognition, and a display unit for displaying the text data converted by the voice recognition means (see, for example, Patent Document 1: Japanese Laid-open Patent Publication No. 2013-135334).

### SUMMARY

According to a first aspect of the present disclosure, there is provided a character communication system including: a memory; and a processor coupled to the memory and the processor configured to: switch, when pressing of a predetermined first button for calling a communication partner is detected on a predetermined screen of a first portable terminal for starting voice call, from the predetermined screen to a first screen including a first input region for inputting a character and a first display region for displaying a character input by the communication partner and display the first screen on the first portable terminal; display, on a second portable terminal of the communication partner, an incoming call screen including a predetermined second button for answering a call from the first portable terminal when the pressing of the predetermined first button is detected; switch the incoming call screen to a second screen including a second input region for inputting a character and a second display region for displaying the character input to the first input region when the pressing of the predetermined second button is detected; and display the character input to the first input region in the second display region by overwriting a character already displayed in the second display region with the character input to the first input region when the character is input to the first input region, and display the character input to the second input region in the first display region by overwriting a character already displayed in the first display region with the character input to the second input region when the character is input to the second input region.

According to a second aspect of the present disclosure, there is provided a character communication system including: a memory; and a processor coupled to the memory and the processor configured to: switch, when pressing of a predetermined first button for calling a communication partner is detected on a predetermined screen of a first portable terminal for starting voice call, from the predetermined screen to a first screen including a first input region for inputting a character and a first display region for displaying a character input by the communication partner and display the first screen on the first portable terminal; display, on a second portable terminal of the communication partner, an incoming call screen including a predetermined second button for answering a call from the first portable terminal when the pressing of the predetermined first button is detected; switch the incoming call screen to a second screen including a second input region for inputting a character and a second display region for displaying the character input to the first input region when the pressing of the predetermined second button is detected; and erase, when the character is input to the first input region, a character already displayed in the second display region and then display the character input to the first input region in the second display region, and erase, when the character is input to the second input region, a character already displayed in the first display region and then displays the character input to the second input region in the first display region.

In the character communication systems of the first and the second aspects of the present disclosure, the processor may sequentially display an input character in the second display region each time the character is input to the first input region, and may sequentially display an input character in the first display region each time the character is input to the second input region.

In the character communication systems of the first and the second aspects of the present disclosure, the first screen may include the first input region, and the first display region corresponding to a number of communication partners, and the second screen may include the second input region, and the second display region corresponding to a number of communication participants except for the communication partners.

In the character communication systems of the first and the second aspects of the present disclosure, the processor may set mute to the first portable terminal to block the input of voice to the first portable terminal after the first screen is displayed, and the processor may set mute to the second portable terminal to block the input of voice to the second portable terminal after the second screen is displayed.

In the character communication systems of the first and the second aspects of the present disclosure, the processor may perform control on the first portable terminal to block the input of voice to the first portable terminal after the first screen is displayed, and the processor may perform control on the second portable terminal to block the input of sound to the second portable terminal after the second screen is displayed.

In the character communication systems of the first and the second aspects of the present disclosure, the processor may display the first screen after displaying the second screen.

According to a third aspect of the present disclosure, there is provided a non-transitory computer-readable recording medium having stored therein a program for causing a computer to execute a process. The process includes: switching, when pressing of a predetermined first button for calling a communication partner is detected on a predetermined screen of a first portable terminal for starting voice call, from the predetermined screen to a first screen including a first input region for inputting a character and a first display region for displaying a character input by the communication partner and displaying the first screen on the first portable terminal; displaying, on a second portable terminal of the communication partner, an incoming call screen including a predetermined second button for answering a call from the first portable terminal when the pressing of the predetermined first button is detected; switching the incoming call screen to a second screen including a second input region for inputting a character and a second display region for displaying the character input to the first input region when the pressing of the predetermined second button is detected; displaying the character input to the first input region in the second display region by overwriting a character already displayed in the second display region with the character input to the first input region when the character is input to the first input region; and displaying the character input to the second input region in the first display region by overwriting a character already displayed in the first display region with the character input to the second input region when the character is input to the second input region.

According to a fourth aspect of the present disclosure, there is provided a character communication method executed by a computer to execute a process. The process includes: switching, when pressing of a predetermined first button for calling a communication partner is detected on a predetermined screen of a first portable terminal for starting voice call, from the predetermined screen to a first screen including a first input region for inputting a character and a first display region for displaying a character input by the communication partner and displaying the first screen on the first portable terminal; displaying, on a second portable terminal of the communication partner, an incoming call screen including a predetermined second button for answering a call from the first portable terminal when the pressing of the predetermined first button is detected; switching the incoming call screen to a second screen including a second input region for inputting a character and a second display region for displaying the character input to the first input region when the pressing of the predetermined second button is detected; displaying the character input to the first input region in the second display region by overwriting a character already displayed in the second display region with the character input to the first input region when the character is input to the first input region; and displaying the character input to the second input region in the first display region by overwriting a character already displayed in the first display region with the character input to the second input region when the character is input to the second input region.

According to a fifth aspect of the present disclosure, there is provided a non-transitory computer-readable recording medium having stored therein a program for causing a computer to execute a process. The process includes: switching, when pressing of a predetermined first button for calling a communication partner is detected on a predetermined screen of a first portable terminal for starting voice call, from the predetermined screen to a first screen including a first input region for inputting a character and a first display region for displaying a character input by the communication partner and displaying the first screen on the first portable terminal; displaying, on a second portable terminal of the communication partner, an incoming call screen including a predetermined second button for answering a call from the first portable terminal when the pressing of the predetermined first button is detected; switching the incoming call screen to a second screen including a second input region for inputting a character and a second display region for displaying the character input to the first input region when the pressing of the predetermined second button is detected; erasing, when the character is input to the first input region, a character already displayed in the second display region and then displaying the character input to the first input region in the second display region; and erasing, when the character is input to the second input region, a character already displayed in the first display region and then displaying the character input to the second input region in the first display region.

According to a sixth aspect of the present disclosure, there is provided a character communication method executed by a computer to execute a process. The process includes: switching, when pressing of a predetermined first button for calling a communication partner is detected on a predetermined screen of a first portable terminal for starting voice call, from the predetermined screen to a first screen including a first input region for inputting a character and a first display region for displaying a character input by the communication partner and displaying the first screen on the first portable terminal; displaying, on a second portable terminal of the communication partner, an incoming call screen including a predetermined second button for answering a call from the first portable terminal when the pressing of the predetermined first button is detected; switching the incoming call screen to a second screen including a second input region for inputting a character and a second display region for displaying the character input to the first input region when the pressing of the predetermined second button is detected; erasing, when the character is input to the first input region, a character already displayed in the second display region and then displaying the character input to the first input region in the second display region; and erasing, when the character is input to the second input region, a character already displayed in the first display region and then displaying the character input to the second input region in the first display region.

### BRIEF DESCRIPTION OF THE DRAWINGS

FIG. 1 is a diagram illustrating an example of a character communication system;

FIG. 2 is an example of a hardware configuration of the character communication system;

FIG. 3 is an example of a functional configuration of the character communication system;

FIG. 4 is an example of character information;

FIG. 5 is a flowchart illustrating an example of the operation of the character communication system;

FIG. 6 is an example of a home screen;

FIG. 7A illustrates an example of an outgoing call screen and FIG. 7B illustrates an example of an incoming call screen;

FIG. 8A illustrates an example of a first screen, and FIG. 8B illustrates an example of a second screen;

FIG. 9 is a flowchart illustrating another example of the operation of the character communication system;

FIG. 10A is a diagram for explaining an example of sequential display, and

FIG. 10B is a diagram for explaining an example of inputting characters on the first screen and an example of displaying characters on the second screen;

FIG. 11A is a diagram illustrating an example of character communication, and FIG. 11B is a diagram illustrating another example of character communication;

FIG. 12 is a diagram for explaining a state in which characters are overwritten;

FIG. 13 is an example of a process sequence diagram of an outgoing call side;

FIG. 14 is an example of a process sequence diagram of an incoming call side;

FIG. 15A is a diagram illustrating a part of a source code for displaying the outgoing call screen, and FIG. 15B is a diagram illustrating a part of a source code for displaying the second screen;

FIG. 16 is a diagram illustrating a part of a source code for suspending expansion of a second screen when a response button is pressed;

FIG. 17 is a diagram illustrating a part of a source code for expanding the second screen at timing of foreground;

FIG. 18 is a diagram illustrating a part of a source code for fetching and holding a room ID;

FIG. 19A is a diagram illustrating a part of a source code for non-displaying the outgoing call screen, and FIG. 19B is a diagram illustrating a part of a source code for notifying a non-display state;

FIG. 20 is a diagram illustrating a part of a source code for displaying the first screen;

FIG. 21 is a diagram illustrating a part of a source code for setting mute; and

FIG. 22 is a diagram illustrating a part of another source code for setting mute.

### DESCRIPTION OF EMBODIMENTS

However, the above-described communication terminal device includes a voice synthesizing means for converting the text data into the voice signal by the voice synthesis. The communication terminal device further includes the voice recognition means for converting the voice signal from the voice terminal into the text data by the voice recognition. As described above, since the communication terminal device performs conversion processing by the voice synthesis or the voice recognition, which generates a large processing load and lacks real-time performance.

Accordingly, an object of one aspect of the present disclosure is to provide a character communication system, a non-transitory computer-readable recording medium, and a character communication method that perform communication avoiding vocalization while improving the real-time performance.

Hereinafter, an embodiment of the present disclosure will be described with reference to the drawings.

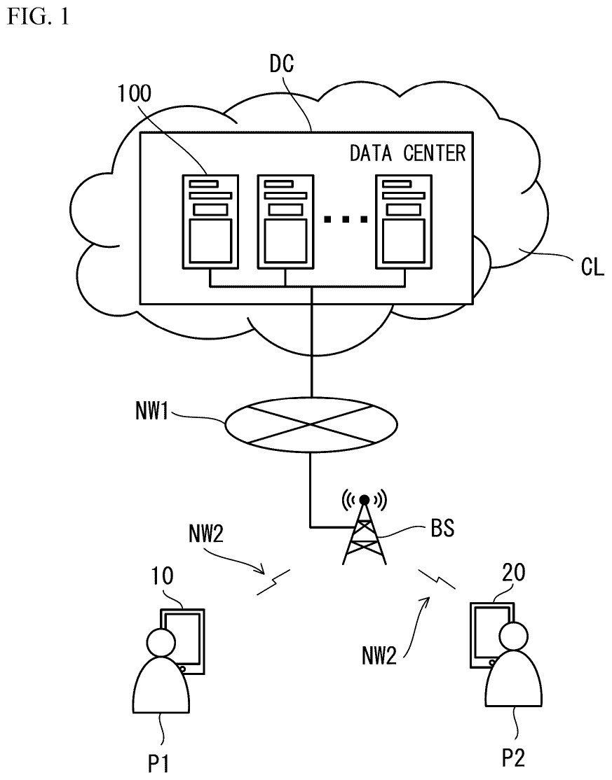

As illustrated in FIG. 1, a character communication system 100 is implemented in a data center DC on a cloud (specifically, a public cloud) CL. In FIG. 1, the character communication system 100 is illustrated as one server, but various functions of the character communication system 100 may be distributed to a plurality of servers according to the functions, and may communicate with each other to cooperate with each other.

The character communication system 100 communicates with a portable terminal 10 possessed by a user P1 using the character communication system 100 and a portable terminal 20 possessed by a user P2 using the character communication system 100. Although not illustrated, the character communication system 100 may communicate with portable terminals held by one or more users other than the users P1 and P2.

The character communication system 100 communicates with the portable terminals 10 and 20 via a wired communication network NW1, a portable base station BS, and a wireless communication network NW2. The wired communication network NW1 may be, for example, a communication network such as Internet or LAN (Local Area Network). The wireless communication network NW2 is, for example, a communication network using LTE (Long Term Evolution).

For example, when the portable terminals 10 and 20 are included in a communicable region of the portable base station BS, the character communication system 100 communicates with the portable terminals 10 and 20 via the wired communication network NW1, the portable base station BS, and the wireless communication network NW2. A character communication application for communicating with the character communication system 100 is installed in each of the portable terminals 10 and 20. The character communication application is an application program (or application software) that realizes character communication between the users P1 and P2 in cooperation with the character communication system 100. In FIG. 1, a smartphone is illustrated as an example of the portable terminals 10 and 20, but each of the portable terminals 10 and 20 may be a terminal having at least portability and a communication function, such as a tablet terminal, a smart watch, a VR (Virtual Reality) device, a game terminal, or a wearable device.

In this embodiment, the user P2 represents an acquaintance of the user P1. The acquaintances include, for example, friends, family, relatives, colleagues, superiors, subordinates, and the like, but are not particularly limited thereto as long as they have some kind of relationship with the user P1. When the user P1 operates the portable terminal 10 to start the character communication application, the character communication system 100 displays a home screen on the portable terminal 10. The home screen is an example of a predetermined screen. Although the details will be described later, the home screen includes a call button for calling the user P2 or the like by a ring tone or the like. The call button is an example of a predetermined first button.

For example, when the user P1 presses the call button associated with the user P2, the character communication system 100 transmits a call control signal for calling the user P2 to the portable terminal 20 by the same function as the function of the telephone, and displays an outgoing call screen on the portable terminal 10. When the portable terminal 20 receives the call control signal, the portable terminal 20 displays an incoming call screen and requests the user P2 to answer or reject the incoming call.

When the user P2 answers the incoming call, the character communication system 100 displays, on the portable terminal 10, a first screen including a first input region for inputting characters and a first display region for sequentially displaying characters input by the user P2 who is a communication partner of the user P1. When the user P2 answers the incoming call, the character communication system 100 displays, on the portable terminal 20, a second screen including a second input region for inputting characters and a second display region for sequentially displaying the characters input to the first input region. The first screen is displayed after the second screen is displayed, as will be described in detail later. Data to be input to the first input region and the second input region is not limited to characters, but may be numerals, symbols, marks, or the like.

Thus, when the user P1 inputs characters in the first input region, the input characters are sequentially displayed in the second display region of the second screen displayed on the portable terminal 20 of the user P2. Similarly, when the user P2 inputs characters in the second input region, the input characters are sequentially displayed in the first display region of the first screen displayed on the portable terminal 10 of the user P1. Thus, the present embodiment not only enables calls that avoid vocalization, but also improves real-time performance compared to a case where conversion processing is performed by the voice synthesis or voice recognition, since the characters are sequentially displayed in the display region of the other party in response to the input of the characters.

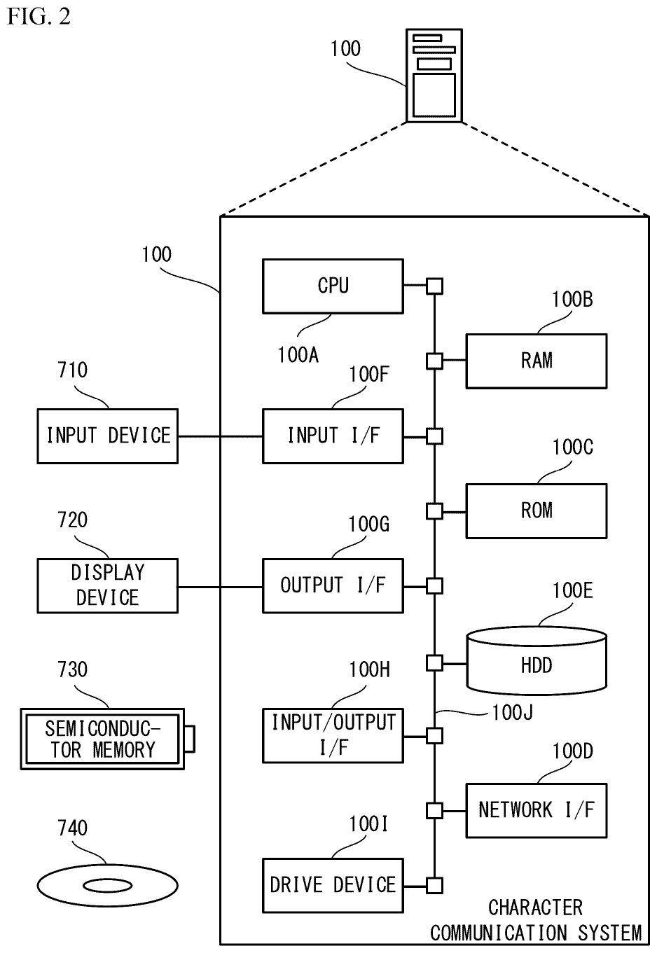

Next, the hardware configuration of the character communication system 100 will be described with reference to FIG. 2. The hardware configuration of each of the portable terminals 10 and 20 is basically the same as that of the character communication system 100, and therefore, a detailed description thereof will be omitted.

As illustrated in FIG. 2, the character communication system 100 includes a CPU 100A as a processor, a RAM 100B and a ROM 100C as memories, and a network I/F (interface) 100D. The character communication system 100 may include at least one of a hard disk drive (HDD) 100E, an input I/F 100F, an output I/F 100G, an input/output I/F 100H, and a drive device 100I, as needed. The CPU 100A, the RAM100B, the ROM100C, the network I/F 100D, the HDD 100E, the input I/F 100F, the output I/F 100G, the input/output I/F 100H, and the drive device 100I are connected to each other by an internal bus 100J. At least the CPU 100A and the RAM100B cooperate with each other to realize the computer.

An input device 710 is connected to the input I/F 100F. The input device 710 may be, for example, a keyboard or a mouse. The output I/F 100G is connected to a display device 720. The display device 720 may be, for example, a liquid crystal display. The input/output I/F 100H is connected to a semiconductor memory 730. Examples of the semiconductor memory 730 include a USB (Universal Serial Bus) memory and a flash memory. The input/output I/F 100H reads the character communication program stored in the semiconductor memory 730. The input I/F 100F and the input/output I/F 100H include, for example, USB ports. The output I/F 100G includes, for example, a display port.

A portable recording medium 740 is inserted into the drive device 100I. As the portable recording medium 740, for example, a removable disk such as a CD (Compact Disc)-ROM or a DVD (Digital Versatile Disc) is available. The drive device 100I reads the character communication program stored in the portable recording medium 740. The network I/F100D includes, for example, a LAN port. The network I/F100D is connected to the wired communication network NW1.

The CPU 100A stores the character communication program stored in the ROM 100C or the HDD 100E into the RAM 100B. The CPU100A stores the character communication program stored in the portable recording medium 740 into the RAM 100B. The CPU 100A executes the stored character communication program, whereby the character communication system 100 realizes various functions described later and executes various processes described later. The character communication program may be in accordance with a flowchart described later.

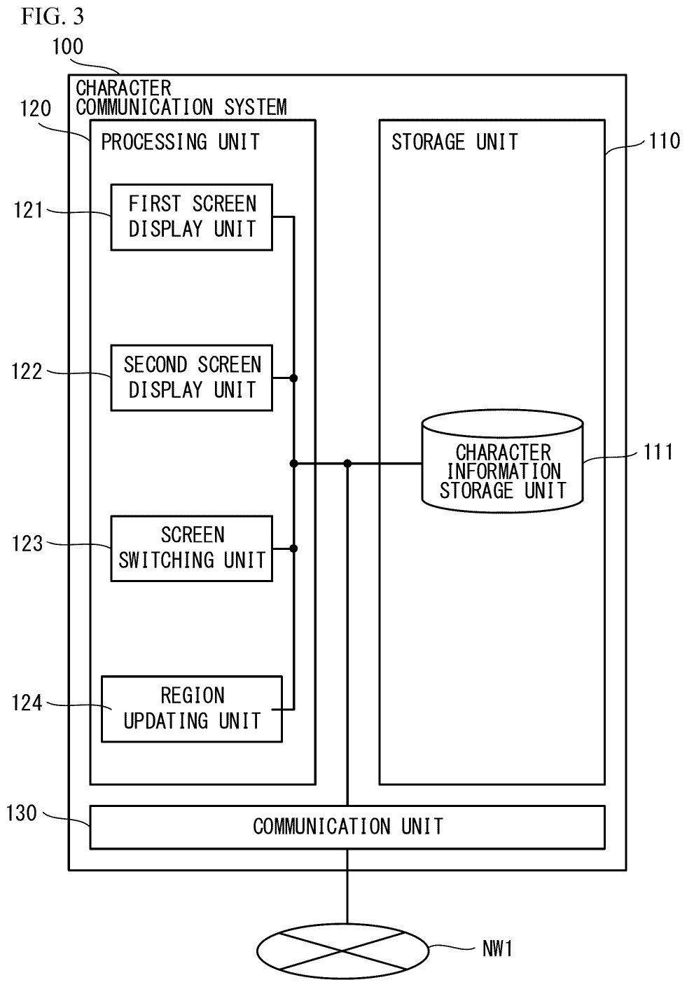

Next, the functional configuration of the character communication system 100 will be described with reference to FIG. 3. FIG. 3 illustrates a main part of the functions of the character communication system 100.

As illustrated in FIG. 3, the character communication system 100 includes a storage unit 110, a processing unit 120, and a communication unit 130. The storage unit 110 can be realized by one or both of the RAM 100B and the HDD 100E. The processing unit 120 can be realized by the CPU 100A described above. The communication unit 130 can be realized by the above-described communication I/F 100D. Therefore, the storage unit 110, the processing unit 120, and the communication unit 130 are connected to each other. The storage unit 110 includes a character information storage unit 111. The processing unit 120 includes a first screen display unit 121, a second screen display unit 122, a screen switching unit 123, and a region updating unit 124.

Note that a part of the character information storage unit 111, the first screen display unit 121, the second screen display unit 122, the screen switching unit 123, and the region updating unit 124 may be included in each of the portable terminals 10 and 20. In other words, a part of the functions of the character communication system 100 may be realized by the character communication application.

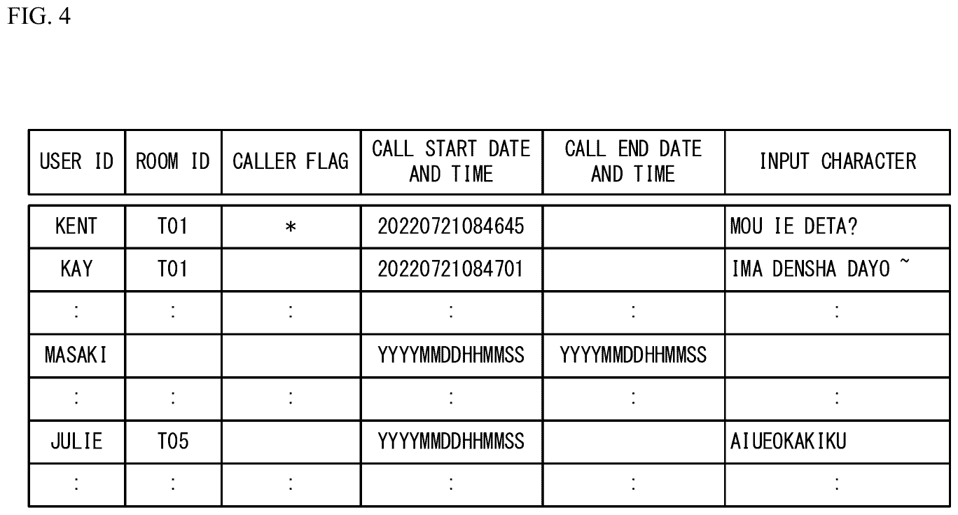

As illustrated in FIG. 4, the character information storage unit 111 stores character information including characters input to the first input region and the second input region. The character information includes a plurality of items such as a user ID, a room ID, a caller flag, a call start date and time, a call end date and time, and an input character. Identifiers for identifying the users P1 and P2, and the like are registered in the item of the user ID. In the present embodiment, for example, the name “Kent” of the user P1 and the name “Kay” of the user P2 are registered as the identifiers, but the user ID and the names of the users P1 and P2 may be registered separately by adding the item of the user name.

Identifiers for identifying the character communication made by the users P1 and P2 are registered in the item of the room ID. In the present embodiment, since the call is made by two users P1 and P2 as an example, a common room ID “T01” is registered in the item of the room ID. When the call is made by three or more persons including the users P1 and P2, a room ID common to the three persons is registered in the item of the room ID.

A symbol for identifying a caller who has called a communication partner is registered in the item of the caller flag. In the present embodiment, since the user P1 is performing an operation to call the user P2 who is the communication partner, the symbol “*” is registered in the caller flag of the user P1. A date and time when the call is started is registered in the item of the call start date and time. In the case of the caller, a date and time when the calling operation is performed is registered in the item of the call start date and time. In the case of the communication partner, a date and time when the operation to answer the call is performed is registered in the item of the call start date and time. A date and time when the call is ended is registered in the item of the call end date and time. Regardless of the type of the caller and the communication partner, a date and time when the call is disconnected is registered in the item of the call end date and time.

Characters input to the first input region or the second input region are input to the item of the input character. Accordingly, when the user P1, who is the caller, inputs characters in the first input region, the characters input to the first input region are registered in the item of the input character of the user P1. When the user P2, who is the communication partner of the caller, inputs characters in the second input region, the characters input to the second input region are registered in the item of the input character of the user P2.

When the first screen display unit 121 detects the pressing of a call button for calling the communication partner on the home screen of the portable terminal 10, the first screen display unit 121 switches from the outgoing call screen to the first screen including the first input region and the first display region and displays the first screen on the portable terminal 10. When the second screen display unit 122 detects the pressing of the call button, the second screen display unit 122 displays the incoming call screen including an answer button for answering the call from the portable terminal 10 on the portable terminal 20. The answer button is an example of a predetermined second button. When the screen switching unit 123 detects the pressing of the answer button, the screen switching unit 123 switches the incoming call screen to the second screen including the second input region and the second display region.

When characters are input to the first input region, the region updating unit 124 sequentially displays the characters input to the first input region in the second display region by overwriting characters already displayed in the second display region with the characters input to the first input region. When characters are input to the second input region, the region updating unit 124 sequentially displays the characters input to the second input region in the first display region by overwriting characters already displayed in the first display region with the characters input to the second input region.

When characters are input to the first input region, the region updating unit 124 may erase characters already displayed in the second display region and then sequentially display the characters input to the first input region in the second display region. When characters are input to the second input region, the region updating unit 124 may erase characters already displayed in the first display region and then sequentially display the characters input to the second input region in the first display region.

Furthermore, when characters are input to the first input region, the region updating unit 124 may display the characters input to the first input region in the second display region, following characters already displayed in the second display region without erasing the already displayed characters. When characters are input to the second input region, the region updating unit 124 may display the characters input to the second input region in the first display region, following characters already displayed in the first display region without erasing the already displayed characters. In this case, the characters may not fit in the region such as the first input region or the first display region and be hidden outside the region. Therefore, when the region updating unit 124 determines that the character does not fit in the region, the region updating unit 124 may execute a scroll process for causing the characters to appear based on a scroll operation on the region.

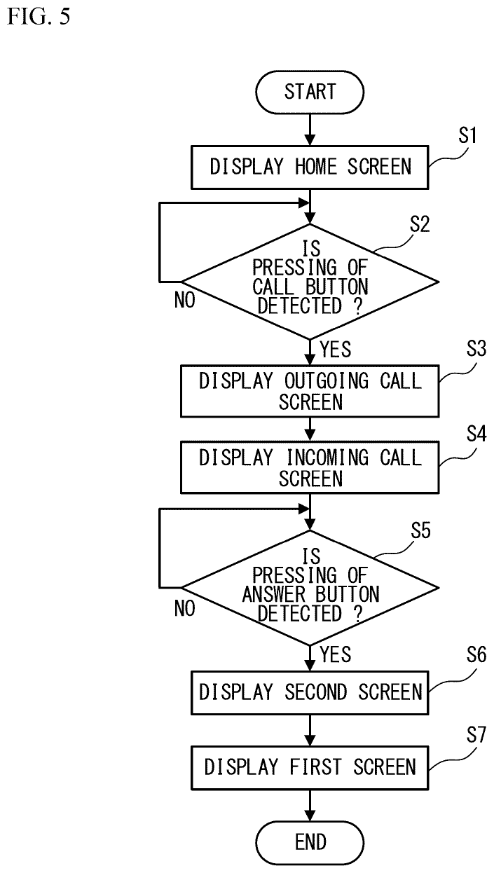

Next, the operation of the character communication system 100 will be described with reference to FIGS. 5 to 8B.

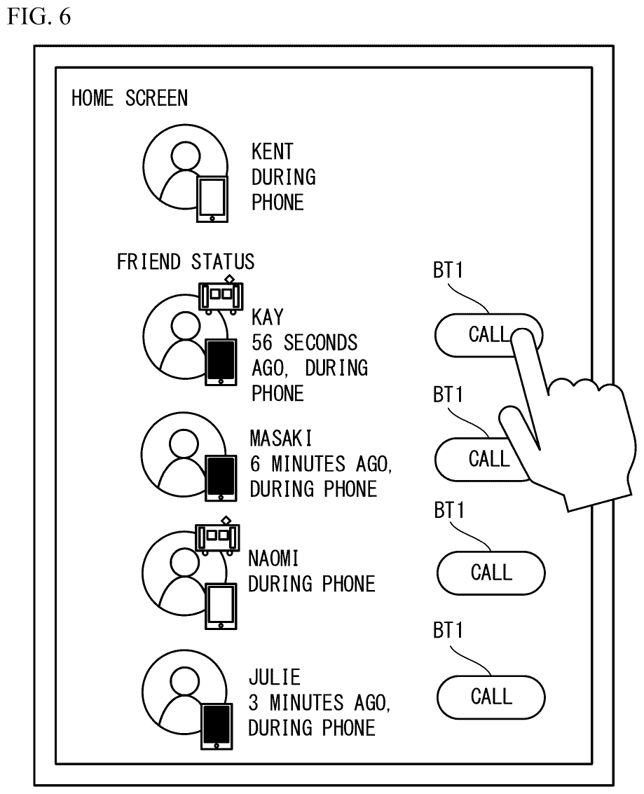

First, as illustrated in FIG. 5, the first screen display unit 121 displays the home screen (step S1). More specifically, the first screen display unit 121 displays the home screen based on an operation (for example, an operation of starting the call application) on the portable terminal 10 by the user P1. As illustrated in FIG. 6, the home screen includes the user ID of the user P1, the user ID of the user P2 who is an acquaintance of the user P1, and call buttons BT1 as a predetermined first button for calling the user P2 by a ring tone. In FIG. 6, the call button BT1 includes “call” as the name of the button, but the name may be changed as appropriate, for example, to “contact”, “outgoing call”, or “CALL”. The call button BT1 is an image.

The user ID may be associated with a deformed image of the face of the user P1 or P2. The home screen may include the states of the portable terminal 10 of the user P1 and the portable terminal 20 of the user P2 (for example, the states of turning on and off the power source), and the present states of the users P1 and P2 (for example, while riding a train, playing a game, or on the phone). The first screen display unit 121 waits until it detects the pressing of the call button BT1 (step S2: NO). In this embodiment, as an example, the user ID “Kent2 is assigned to the user P1, and the user ID “Kay” is assigned to the user P2.

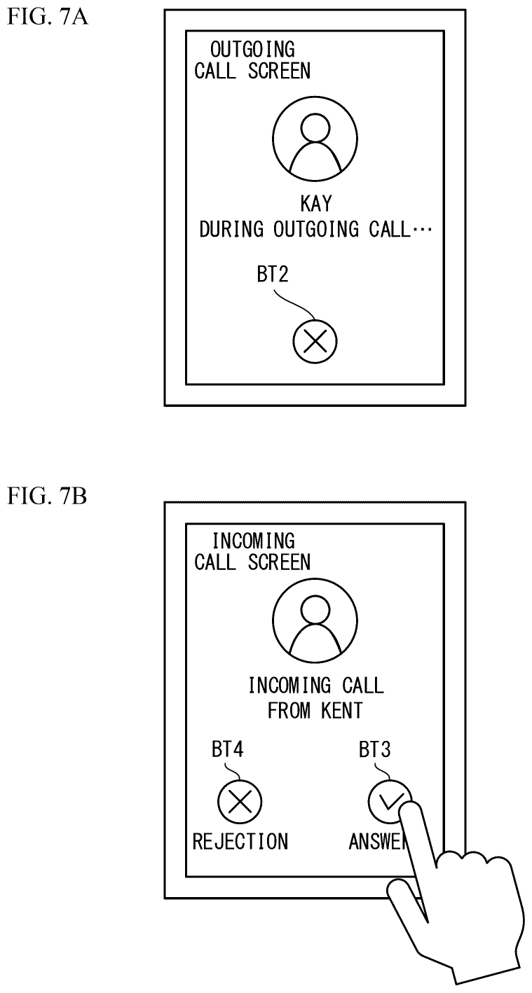

When the first screen display unit 121 detects the pressing of the call button BT1 (step S2: YES), the first screen display unit 121 displays the outgoing call screen (step S3). The outgoing call screen is a screen indicating that the portable terminal 10 is in the middle of calling. As illustrated in FIG. 7A, the outgoing call screen includes the user ID of the communication partner such as a user ID “Kay”, an image of the face of the user P2, and a stop button BT2 for stopping the outgoing call. When the user P1 presses the stop button BT2, the first screen display unit 121 stops the outgoing call process and switches the outgoing call screen to the home screen.

On the other hand, when the first screen display unit 121 displays the outgoing call screen, the second screen display unit 122 displays the incoming call screen (step S4). The incoming call screen is a screen indicating that the portable terminal 20 is in the middle of receiving an incoming call. As illustrated in FIG. 7B, the incoming call screen may include the user ID of the communication partner such as the user ID “Kent” and the image of the face of the user P1, or may not include such a user ID and an image. For example, when the user P1 sets the portable terminal 10 to be non-notification, that is, not to notify the user ID and the image of the user P1, the incoming call screen does not include the user ID and the image of the face of the user P1.

The incoming call screen includes an answer button BT3 as a predetermined second button for answering the incoming call and a rejection button BT4 for rejecting the incoming call. In FIG. 7B, the answer button BT3 includes a symbol such as a check mark, but the symbol may be appropriately changed to, for example, characters such as “answer a call” or “OK”, or the symbol may be appropriately changed to a design of a receiver or the like. The second screen display unit 122 waits until it detects the pressing of the answer button BT3 (step S5: NO).

If the user P2 presses the reject button BT4 before detecting the pressing of the answer button BT3, the second screen display unit 122 rejects the incoming call. In this case, the second screen display unit 122 switches the incoming call screen to another screen. The another screen is, for example, a screen displayed immediately before the incoming call screen.

When the second screen display unit 122 detects the pressing of the answer button BT3 (step S5: YES), the second screen display unit 122 displays the second screen (step S6). More specifically, the second screen display unit 122 switches from the incoming call screen to the second screen and displays the second screen on the portable terminal 20. The second screen is a screen for the user P2 to operate the portable terminal 20 and to perform the character communication.

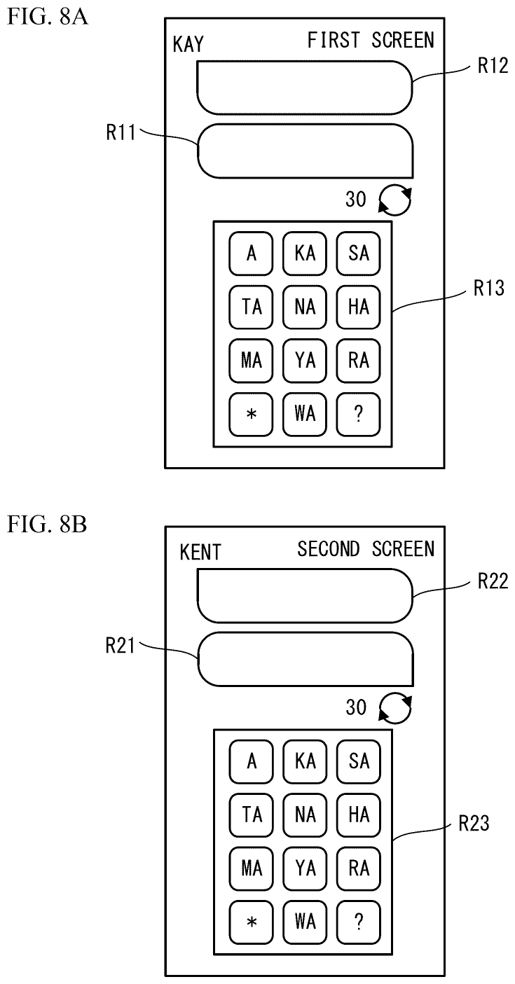

As illustrated in FIG. 8B, the second screen includes a second input region R21 for the user P2 to input characters and a second display region R22 for displaying the characters input by the user P1 as the communication partner. The color of the inside of the second input region R21, the color of the background of the second screen, and the color of a border dividing the second input region R21 and the background of the second screen may be the same, may be different, or may be different in part. For example, all of the color of the inside of the region, the color of the background, and the color of the border may be white. For example, both the color of the inside of the region and the color of the border may be blue, and the color of the background may be white. The second display region R22 is basically the same as the second input region R21, and therefore, a detailed description thereof will be omitted. The color of the inside of the second input region R21 and the color of the inside of the second display region R22 may be the same or different.

The second screen includes a character input section R23 for inputting characters into the second input region R21. Although hiragana (Japanese syllabary characters) and symbols are illustrated as examples of characters in the character input section R23, alphabets and symbols may be illustrated. The user P2 can input characters to the second input region R21 by performing an operation of pressing any character in the character input section R23.

When the second screen display unit 122 displays the second screen, the first screen display unit 121 displays the first screen (step S7), and the process ends. More specifically, the first screen display unit 121 switches from the home screen to the first screen and displays the first screen on the portable terminal 10. The first screen is a screen for the user P1 to operate the portable terminal 10 and to perform the character communication.

As illustrated in FIG. 8A, the first screen includes a first input region R11 for the user P1 to input characters and a first display region R12 for displaying the characters input by the user P2 as the communication partner. The color of the inside of the first input region R11, the color of the background of the first screen, and the color of a border dividing the first input region R11 and the background of the first screen may all be the same, may all be different, or may be different in part. For example, all of the color of the inside of the region, the color of the background, and the color of the border may be white. For example, both the color of the inside of the region and the color of the border may be blue, and the color of the background may be white. The first display region R12 is basically the same as the first input region R11, and therefore, a detailed description thereof will be omitted. The color of the inside of the first input region R11 and the color of the inside of the first display region R12 may be the same or different.

The first screen includes a character input section R13 for inputting characters into the first input region R11. Although hiragana and symbols are illustrated as an example of characters in the character input section R13, alphabets and symbols may be illustrated. The user P1 can input a character in the first input region R11 by performing an operation of pressing any character in the character input section R13.

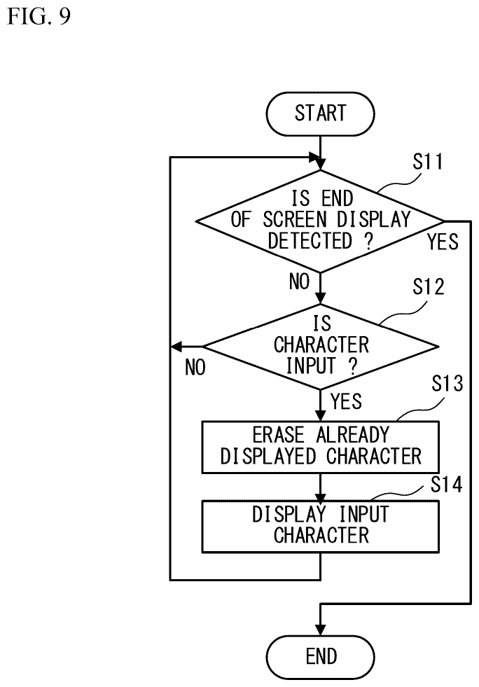

Next, the details of the character communication will be described with reference to FIGS. 9 to 12.

First, as illustrated in FIG. 9, the region updating unit 124 determines whether the end of the screen display is detected (step S11). For example, when the user P1 inputs an instruction to end the display of the first screen to the portable terminal 10, the region updating unit 124 determines that the end of the screen display is detected (step S11: YES). When the user P2 inputs an instruction to end the display of the second screen to the portable terminal 20, the region updating unit 124 similarly determines that the end of the screen display is detected. In this case, the region updating unit 124 ends the process. Although not illustrated, each of the first screen and the second screen may include an input button for inputting such an instruction.

On the other hand, when the end of the screen display is not detected (step S11: NO), the region updating unit 124 determines whether characters are input (step S12). When no character is input (step S12: NO), the region updating unit 124 executes the process of step S11 again. That is, the region updating unit 124 repeats the processing of steps S11 and S12 until the end of the screen display is detected or until the characters are input. That is, the region updating unit 124 waits until either operation is performed.

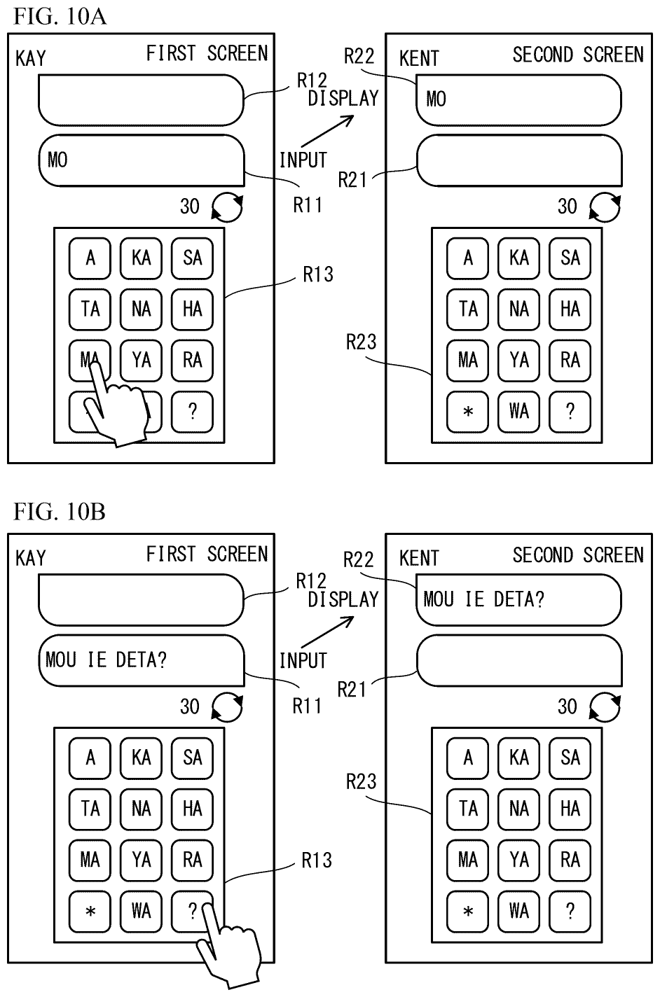

When the characters are input (step S12: YES), the region updating unit 124 erases the already displayed characters (step S13) and displays the input characters (step S14). For example, as illustrated in FIG. 10A, when characters are input to the first input region R11 of the first screen by the user P1, the region updating unit 124 erases the characters already displayed in the second display region R22 of the second screen, and then displays the characters input to the first input region R11 in the second display region R22.

At this time, every time the characters are input to the first input region R11, the region updating unit 124 sequentially acquires the input characters regardless of the screen operation and sequentially displays the input characters in the second display region R22. For this reason, for example, as illustrated in FIG. 10A, when a character “mo” is input to the first input region R11, the region updating unit 124 acquires the character “mo” input to the first input region R11 and displays it in the second display region R22. If the character “mo” input to the first input region R11 is erased, the character “mo” displayed in the second display region R22 is also erased. If the character “mo” input to the first input region R11 is converted, the character “mo” displayed in the second display region R22 is also converted.

In this way, every time characters are input to the first input region R11, the region updating unit 124 sequentially displays the input characters in the second display region R22 in units of input. That is, before the user P1 finishes inputting the text to be transmitted to the user P2, some characters included in the text are sequentially displayed on the portable terminal 20 of the user P2. As described above, the character communication system according to the present embodiment has real-time performance (immediacy). Then, as illustrated in FIG. 10B, when the user P1 has finished inputting the text (i.e., all the characters) to be transmitted to the user P2, the intention of the user P1 is accurately transmitted to the user P2 by the input text.

Although not illustrated, even if characters are input to the second input region R21 of the second screen by the user P2, the region updating unit 124 erases the characters already displayed in the first display region R12 of the first screen and then displays the characters input to the second input region R21 in the first display region R12. The region updating unit 124 sequentially displays the input characters in the first display region R12 every time the characters are input to the second input region R21. Furthermore, the region updating unit 124 may acquire the input characters and display the acquired characters in the second display region R22 every several tens of seconds (for example, 10 seconds or 30 seconds) after the characters are input to the first input region R11.

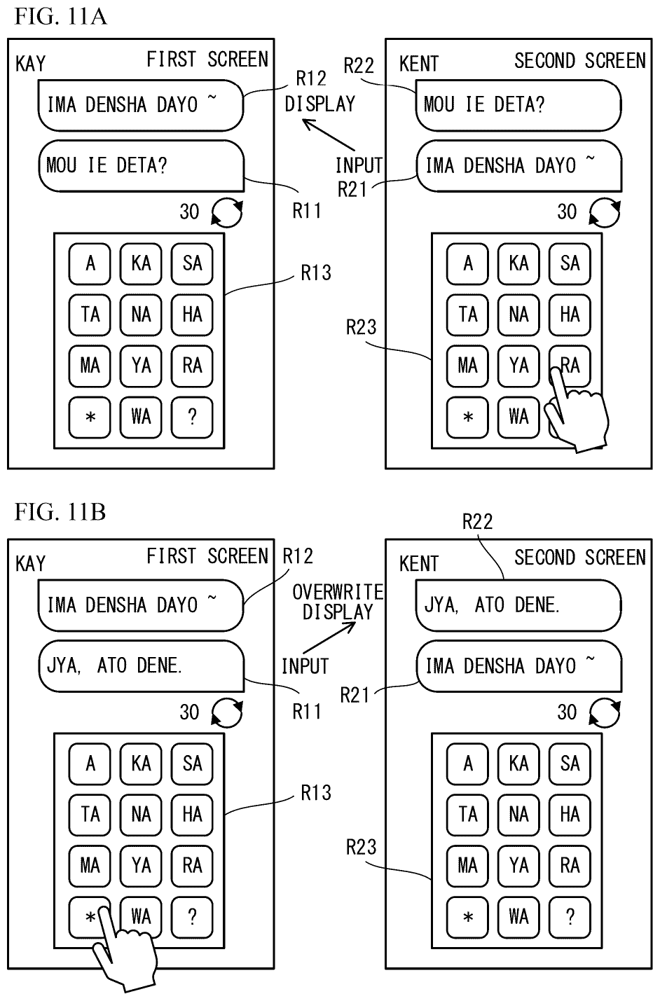

As illustrated in FIG. 11A, the user P2 confirms the text displayed in the second display region R22, and inputs a text corresponding to the text of the user P1 into the second input region R21. As in the above case, every time characters are input to the second input region R21 by the user P2, the region updating unit 124 sequentially displays the input characters in the first display region R12 of the first screen. As a result, the text “IMA DENSHA DAYO˜” expressed by all the characters is finally displayed in the first display region R12. When the process of step S14 is completed, the region updating unit 124 executes the process of step S11 again. In this way, the communication between the users P1 and P2 can be performed while avoiding vocalization the utterance while improving the real-time performance.

With reference to FIGS. 9 to 11A, the description has been made by way of example that the region updating unit 124 erases the characters already displayed in the second display region R22 of the second screen and then displays the characters input to the first input region R11 of the first screen in the second display region R22.

On the other hand, as illustrated in FIG. 11B, when characters are input to the first input region R11, the region updating unit 124 may display the characters input to the first input region R11 in the second display region R22 by overwriting characters already displayed in the second display region R22 with the characters input to the first input region R11. Similarly, when characters are input to the second input region R21, the region updating unit 124 may display the characters input to the second input region R21 in the first display region R12 by overwriting characters already displayed in the first display region R12 with the characters input to the second input region R21.

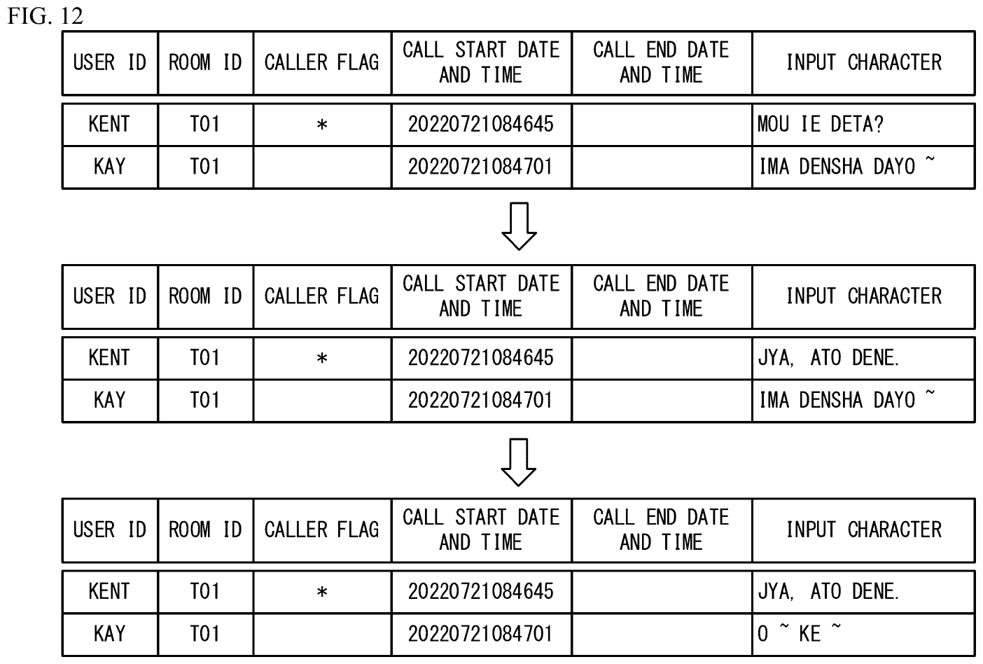

In this case, as illustrated in FIG. 12, in the character information stored in the character information storage unit 111, the past characters input immediately before are overwritten by the latest characters input most recently. For example, as illustrated in the upper part of FIG. 12, a case will be described in which characters “IMA DENSHA DAYO˜” are input by the user P2 as a response to characters “MOU IE DETA?” input by the user P1. In this case, as illustrated in the middle part of FIG. 12, when the user P1 inputs characters “JYA, ATO DENE.”, the region updating unit 124 sets the characters “MOU IE DETA?” as the past characters and the characters “JYA, ATO DENE.” as the latest characters, and overwrites the past characters with the latest characters. The characters “IMA DENSHA DAYO˜” mean “I'm on the train now” in English, the characters “MOU IE DETA?” mean “Have you left home yet?” in English, and the characters “JYA, ATO DENE.” mean “See you later.” in English.

Similarly, as illustrated in the middle part of FIG. 12, a case will be described in which the characters “MOU IE DETA?” are input by the user P1 as a response to the characters “IMA DENSHA DAYO˜” input by the user P2. In this case, as illustrated in the lower part of FIG. 12, when the user P2 inputs the character “O˜KE˜”, the region updating unit 124 sets the characters “IMA DENSHA DAYO˜” as the past characters and the characters “O˜KE˜” as the latest characters, and overwrites the past characters with the latest characters. The characters “O˜KE˜” mean “OK” in English,

As described above, since the already displayed characters are erased or the already displayed characters are overwritten, neither the user P1 nor the user P2 can reconfirm the characters input and displayed in the past. For this reason, as in the case of face-to-face conversation, both the user P1 and the user P2 need to pay attention to the ongoing character communication, and it is assumed that the user P1 and the user P2 are conscious of enjoying the current conversation that is only available now. In particular, according to the present embodiment, since conversion processing such as voice synthesis and voice recognition is not required, a large processing load is not generated, and real-time performance can be secured. On the other hand, when the already displayed characters are not erased, both the user P1 and the user P2 can enjoy the current conversation while looking back on the past character communication.

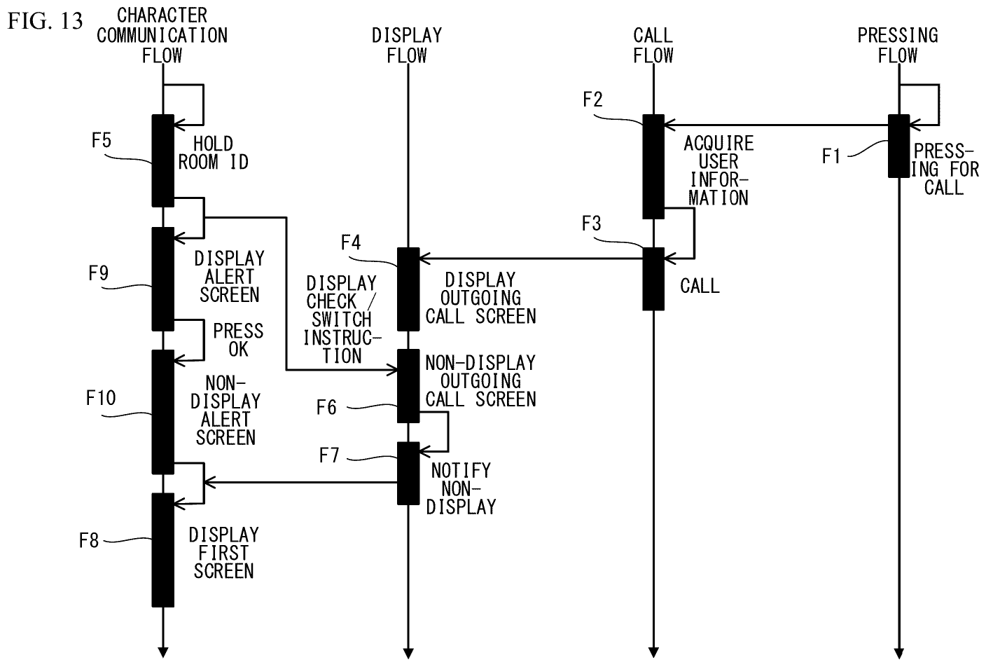

The flow of the above-described outgoing call and incoming call will be described in more detail with reference to FIGS. 13 to 22. For example, as illustrated in FIG. 13, the processing unit 120 of the portable terminal 10 executes processing based on five flows, i.e., a pressing flow, a call flow, a display flow, a character communication flow, and an outgoing call flow (not illustrated).

First, as illustrated in FIG. 13, when the first screen display unit 121 detects the pressing of the call button BT1, the first screen display unit 121 executes a process F1 of selecting a user associated with the pressed call button BT1, as illustrated in the pressing flow. In the present embodiment, the first screen display unit 121 executes a process of selecting the user P2 (see FIG. 6). When the user is selected, the first screen display unit 121 requests the call flow to acquire information of the selected user.

When the acquisition of the information of the selected user is requested, in the call flow, the first screen display unit 121 executes a process F2 of acquiring the information of the selected user. The information of the selected user includes, for example, a telephone number assigned to the portable terminal 20, a user ID, and the like. Upon acquiring the information of the selected user, the first screen display unit 121 executes a process F3 of requesting the display flow to display the outgoing call screen. In addition, the first screen display unit 121 executes a process (not illustrated) of requesting the outgoing call flow to perform an outgoing call process based on the acquired information. Accordingly, in the outgoing call flow (not illustrated), the outgoing call process from the portable terminal 10 to the portable terminal 20, for example, is started.

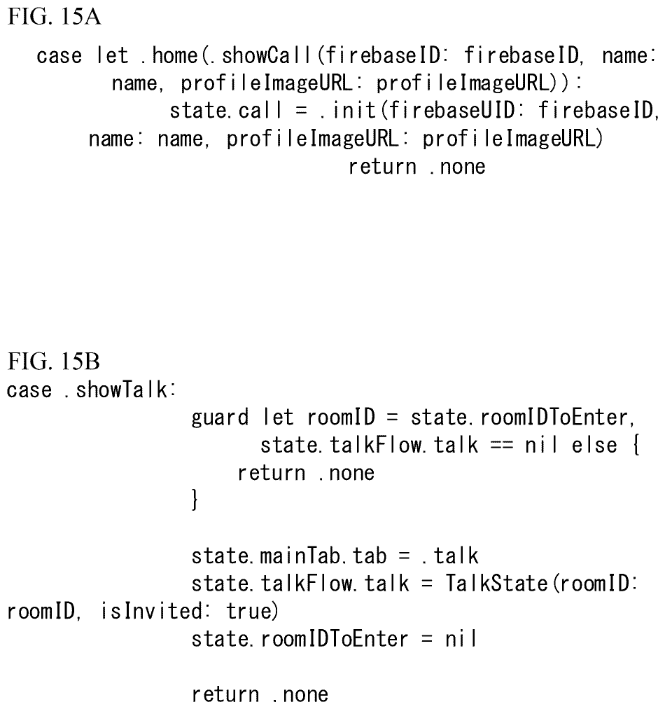

When the display of the outgoing call screen is requested, in the display flow, the first screen display unit 121 executes a process F4 of displaying the outgoing call screen. For example, the first screen display unit 121 executes the process F4 based on a source code illustrated in FIG. 15A. Thereby, the first screen display unit 121 displays the outgoing call screen (see FIG. 7A). The first screen display unit 121 continues to display the outgoing call screen while the outgoing call process is continued without pressing the stop button BT2 (see FIG. 7A).

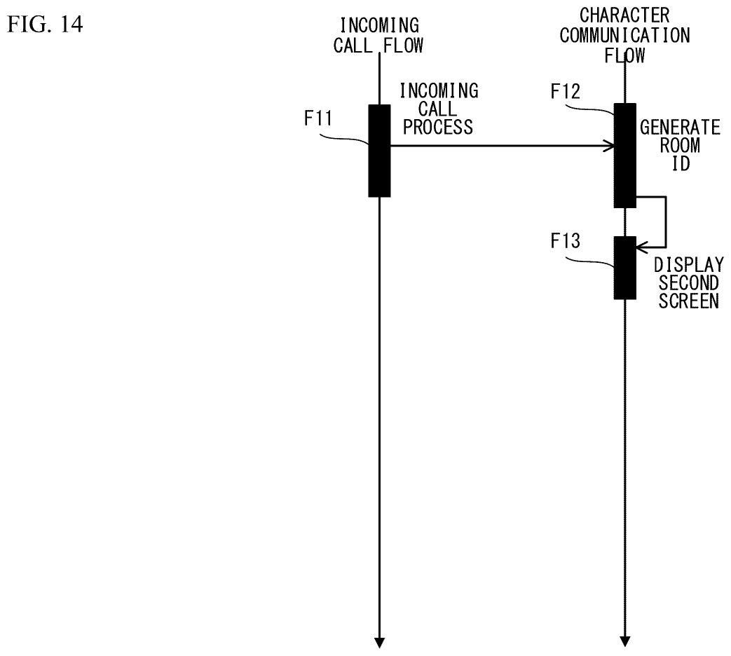

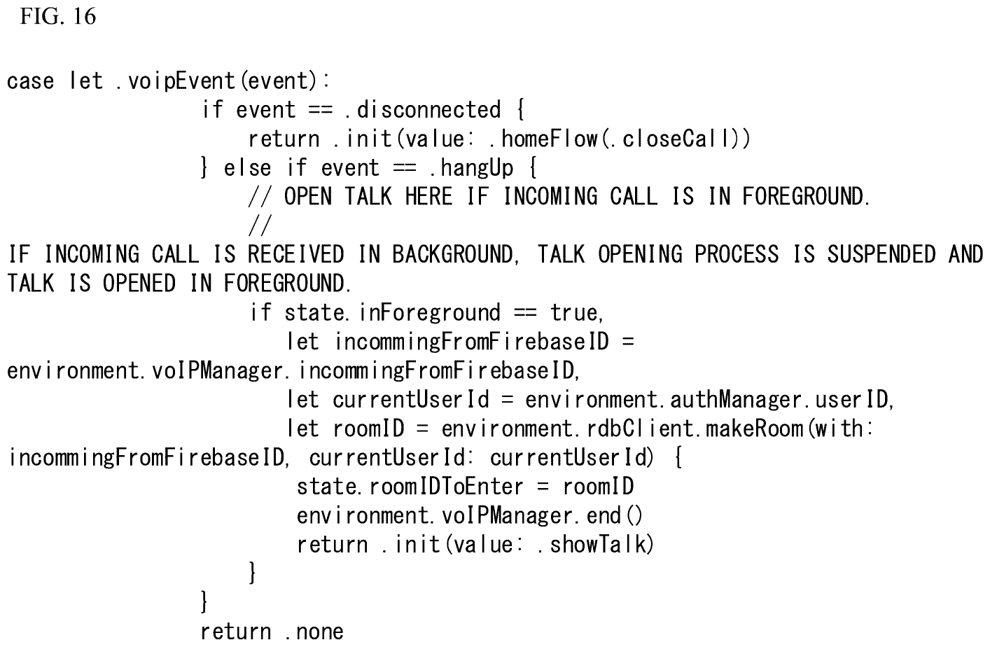

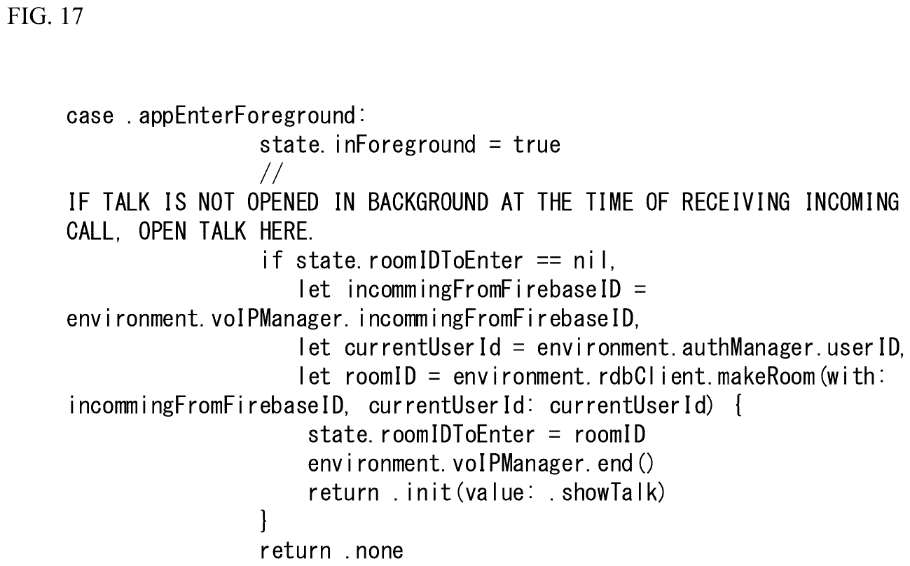

Referring to FIG. 14, when the outgoing call process is executed, the second screen display unit 122 executes a process F11 of requesting the generation of the room ID to the character communication flow, together with the incoming call process with respect to the outgoing call process, as illustrated in the incoming call flow. As a result, as illustrated in the character communication flow, the second screen display unit 122 executes a process F12 of generating the room ID to generate the room ID. For example, the second screen display unit 122 executes the processes F11 and F12 based on source codes illustrated in FIGS. 16 and 17.

After the room ID is generated, the second screen display unit 122 executes a process F13 of displaying the second screen. For example, the second screen display unit 122 executes the process F13 based on a source code illustrated in FIG. 15B. In the source code illustrated in FIG. 15B, “state. talkFlow. talk=TalkState (roomID: roomID, isInvited: true)” corresponds to a process of opening the second screen.

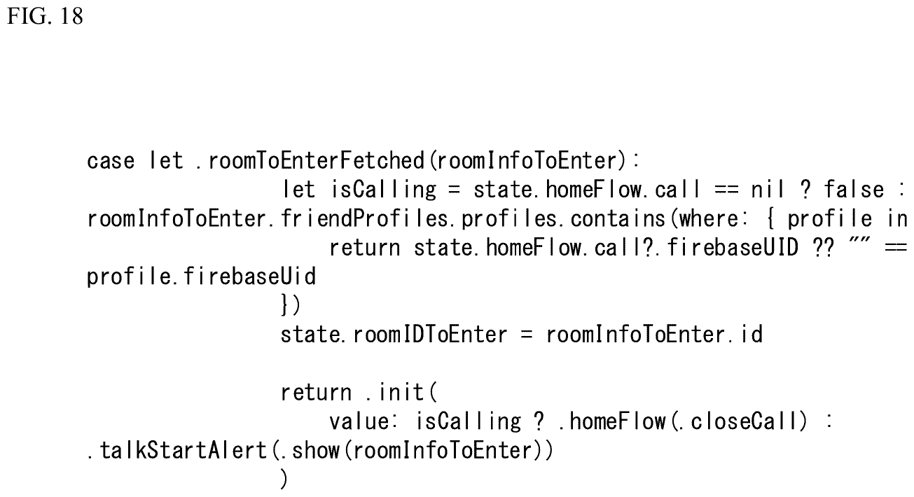

When the second screen display unit 122 displays the second screen, the first screen display unit 121 executes a process F5 of taking in and holding the room ID generated by the second screen display unit 122 in the character communication flow, as illustrated in FIG. 13. For example, the first screen display unit 121 executes the process F5 based on a source code illustrated in FIG. 18. When the process F5 is executed, the first screen display unit 121 determines the display state of the outgoing call screen and determines a subsequent process.

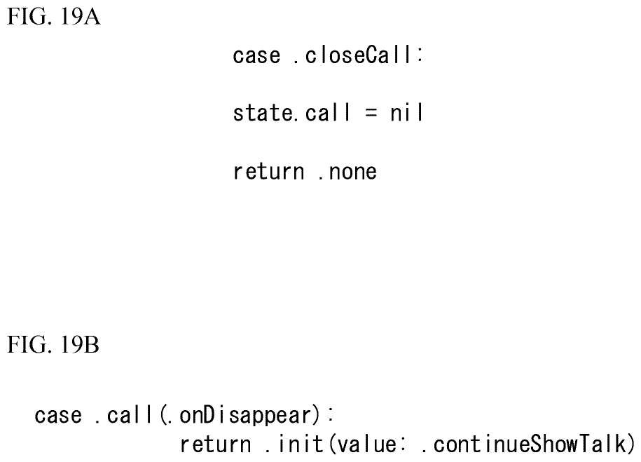

For example, the first screen display unit 121 determines the display state of the outgoing call screen by checking whether “state. call” of the source code illustrated in FIG. 15A is nil. If the “state. call” is not nil, the first screen display unit 121 determines that the outgoing call screen is being displayed and requests the display flow to switch the outgoing call screen. In the display flow, the first screen display unit 121 executes a process F6 of hiding the outgoing call screen. That is, the first screen display unit 121 interrupts or cancels the display of the outgoing call screen. The first screen display unit 121 sets “nil” to “state. call” based on a source code illustrated in FIG. 19A, and hides the outgoing call screen.

When the outgoing call screen is hidden, the first screen display unit 121 executes a process F7 of notifying the character communication flow that the display is hidden. For example, the first screen display unit 121 notifies the character communication flow that the display is hidden based on a source code illustrated in FIG. 19B.

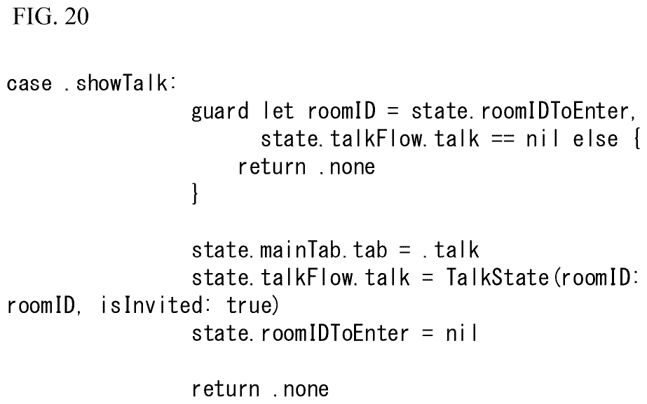

When hiding the display is notified, the first screen display unit 121 executes a process F8 of displaying the first screen in the character communication flow. For example, the first screen display unit 121 executes the process F8 based on a source code illustrated in FIG. 20. In the source code illustrated in FIG. 20, “state. talkFlow. talk=TalkState (roomID: roomID, isInvited: true)” corresponds to the process of opening the first screen. If the “state. call” is nil, the first screen display unit 121 determines that the outgoing call screen is not being displayed, and executes a process F9 of displaying an alert screen (not illustrated) without requesting the display flow to switch the outgoing call screen. When the first screen display unit 121 detects the pressing of an OK button included in the alert screen, the first screen display unit 121 executes a process F10 of hiding the alert screen and then executes the process F8.

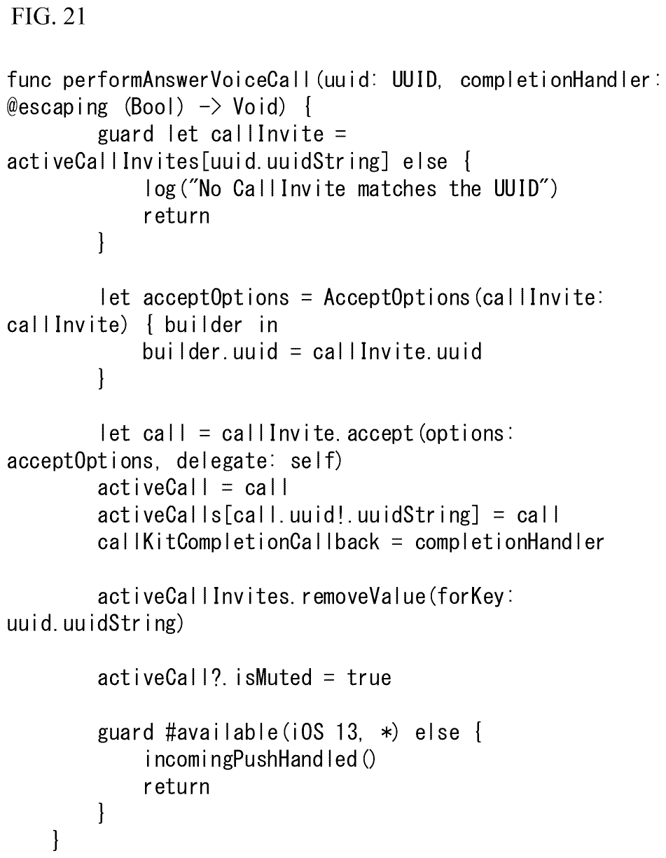

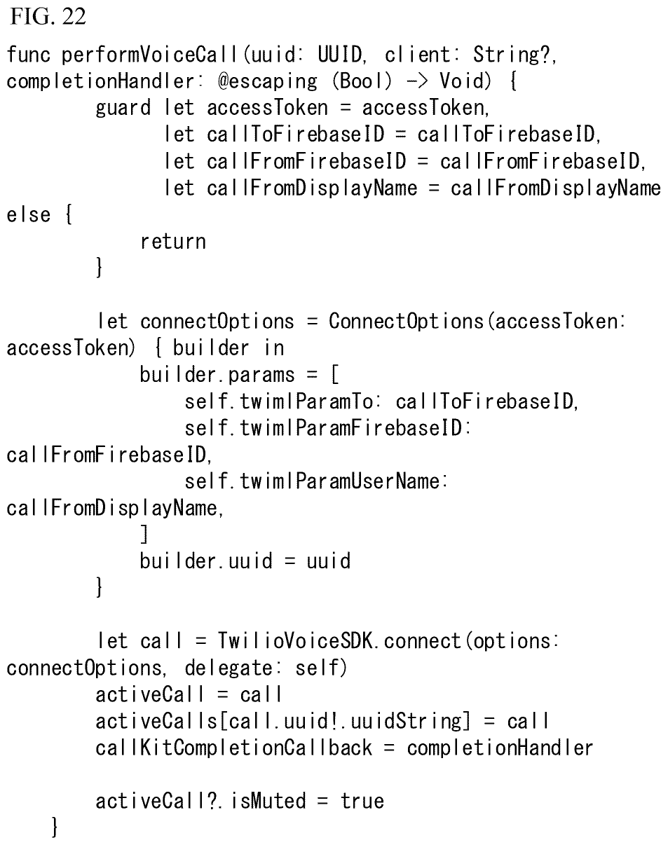

As described above, according to the character communication system ST of the present embodiment, the first screen is displayed after the outgoing call screen is not displayed (i.e., is hidden) due to the display of the second screen. In the incoming call flow after the second screen is displayed, the second screen display unit 122 may set mute for stopping the voice input by a microphone provided in the portable terminal 20. For example, in a source code illustrated in FIG. 21, “activeCall. isMuted=true” corresponds to a process of setting mute. Similarly, in the outgoing call flow after the first screen is displayed, the first screen display unit 121 may set mute for stopping the voice input by a microphone provided in the portable terminal 10. For example, in a source code illustrated in FIG. 22, “activeCall. isMuted=true” corresponds to a process of setting mute. By such a mute setting, the input of the environmental sound existing around the users P1 and P2 is blocked. This allows the user P1 and the user P2 to enjoy the character communication more intensively.

Instead of such a mute setting, the second screen display unit 122 may execute control to block the voice input at the time when the second screen is displayed, and the first screen display unit 121 may execute control to block the voice input at the time when the first screen is displayed. This makes it possible to avoid the mute setting from being canceled by an erroneous operation and the state in which the voice input is enabled from being restored.

Although preferred embodiments of the present disclosure have been described in detail, the present disclosure is not limited to specific embodiments, and various modifications and changes can be made within the scope of the gist of the present invention described in the claims.

For example, the first screen may include a first input region R11, and a plurality of first display regions R12 corresponding to the number of communication partners. The second screen may include a second input region R21, and a plurality of second display regions R22 corresponding to the number of communication participants except for the communication partner. In order to realize such a call between three or more persons, the screen switching unit 123 may switch from, for example, the first screen or the second screen to the home screen in accordance with the operation of the user P1 or the user P2, and wait until the pressing of the call button BT1 is detected.

The relationship between the positions of the first input region R11 and the plurality of first display regions R12 may be changed as appropriate. For example, the first input region R11 and the plurality of first display regions R12 may be arranged in a row. In this case, for example, the first input region R11 is disposed between any one of the plurality of first display regions R12 and the character input section R13. In the case of, for example, the four party call, the first input region R11 and the three first display regions R12 may be arranged in four quadrants. In addition, in the case of the four party call, the first display region R12 may be divided into three. The relationship between the positions of the second input region R21 and the plurality of second display regions R22 is the same as the relationship between the positions of the first input region R11 and the plurality of first display regions R12, and therefore, the detailed description thereof will be omitted.

Furthermore, for example, in the above-described embodiment, a physical server is used as an example of the character communication system 100, but the character communication system 100 may be a virtual server. Furthermore, the functions of the character communication system 100 may be distributed to a plurality of servers according to the load or the type of service, or the respective storage units may be distributed to a plurality of storage units according to the load or the management aspect.

What is claimed is:

1. A character communication system comprising:
a memory; and
a processor coupled to the memory and the processor configured to:
switch, when pressing of a predetermined first button for calling a communication partner is detected on a predetermined screen of a first portable terminal for starting voice call, from the predetermined screen to a first screen including a first input region for inputting a character and a first display region for displaying a character input by the communication partner and display the first screen on the first portable terminal;
display, on a second portable terminal of the communication partner, an incoming call screen including a predetermined second button for answering a call from the first portable terminal when the pressing of the predetermined first button is detected;
switch the incoming call screen to a second screen including a second input region for inputting a character and a second display region for displaying the character input to the first input region when the pressing of the predetermined second button is detected; and
display the character input to the first input region in the second display region by overwriting a character already displayed in the second display region with the character input to the first input region when the character is input to the first input region, and display the character input to the second input region in the first display region by overwriting a character already displayed in the first display region with the character input to the second input region when the character is input to the second input region.

2. A character communication system comprising:
a memory; and
a processor coupled to the memory and the processor configured to:
switch, when pressing of a predetermined first button for calling a communication partner is detected on a predetermined screen of a first portable terminal for starting voice call, from the predetermined screen to a first screen including a first input region for inputting a character and a first display region for displaying a character input by the communication partner and display the first screen on the first portable terminal;
display, on a second portable terminal of the communication partner, an incoming call screen including a predetermined second button for answering a call from the first portable terminal when the pressing of the predetermined first button is detected;
switch the incoming call screen to a second screen including a second input region for inputting a character and a second display region for displaying the character input to the first input region when the pressing of the predetermined second button is detected; and
erase, when the character is input to the first input region, a character already displayed in the second display region and then display the character input to the first input region in the second display region, and erase, when the character is input to the second input region, a character already displayed in the first display region and then displays the character input to the second input region in the first display region.

3. The character communication system according to claim 1, wherein
the processor sequentially displays an input character in the second display region each time the character is input to the first input region, and sequentially displays an input character in the first display region each time the character is input to the second input region.

4. The character communication system according to claim 1, wherein
the first screen includes the first input region, and the first display region corresponding to a number of communication partners, and
the second screen includes the second input region, and the second display region corresponding to a number of communication participants except for the communication partners.

5. The character communication system according to claim 1, wherein
the processor sets mute to the first portable terminal to block the input of voice to the first portable terminal after the first screen is displayed, and
the processor sets mute to the second portable terminal to block the input of voice to the second portable terminal after the second screen is displayed.

6. The character communication system according to claim 1, wherein
the processor performs control on the first portable terminal to block the input of voice to the first portable terminal after the first screen is displayed, and
the processor performs control on the second portable terminal to block the input of sound to the second portable terminal after the second screen is displayed.

7. The character communication system according to claim 1, wherein
the processor displays the first screen after displaying the second screen.

8. The character communication system according to claim 2, wherein
the processor sequentially displays an input character in the second display region each time the character is input to the first input region, and sequentially displays an input character in the first display region each time the character is input to the second input region.

9. The character communication system according to claim 2, wherein
the first screen includes the first input region, and the first display region corresponding to a number of communication partners, and
the second screen includes the second input region, and the second display region corresponding to a number of communication participants except for the communication partners.

10. The character communication system according to claim 2, wherein
the processor sets mute to the first portable terminal to block the input of voice to the first portable terminal after the first screen is displayed, and
the processor sets mute to the second portable terminal to block the input of voice to the second portable terminal after the second screen is displayed.

11. The character communication system according to claim 2, wherein
the processor performs control on the first portable terminal to block the input of voice to the first portable terminal after the first screen is displayed, and
the processor performs control on the second portable terminal to block the input of sound to the second portable terminal after the second screen is displayed.

12. The character communication system according to claim 2, wherein
the processor displays the first screen after displaying the second screen.

13. A non-transitory computer-readable recording medium having stored therein a program for causing a computer to execute a process, the process comprising:
switching, when pressing of a predetermined first button for calling a communication partner is detected on a predetermined screen of a first portable terminal for starting voice call, from the predetermined screen to a first screen including a first input region for inputting a character and a first display region for displaying a character input by the communication partner and displaying the first screen on the first portable terminal;
displaying, on a second portable terminal of the communication partner, an incoming call screen including a predetermined second button for answering a call from the first portable terminal when the pressing of the predetermined first button is detected;
switching the incoming call screen to a second screen including a second input region for inputting a character and a second display region for displaying the character input to the first input region when the pressing of the predetermined second button is detected;
displaying the character input to the first input region in the second display region by overwriting a character already displayed in the second display region with the character input to the first input region when the character is input to the first input region; and
displaying the character input to the second input region in the first display region by overwriting a character already displayed in the first display region with the character input to the second input region when the character is input to the second input region.

14. A character communication method executed by a computer to execute a process, the process comprising:
switching, when pressing of a predetermined first button for calling a communication partner is detected on a predetermined screen of a first portable terminal for starting voice call, from the predetermined screen to a first screen including a first input region for inputting a character and a first display region for displaying a character input by the communication partner and displaying the first screen on the first portable terminal;
displaying, on a second portable terminal of the communication partner, an incoming call screen including a predetermined second button for answering a call from the first portable terminal when the pressing of the predetermined first button is detected;
switching the incoming call screen to a second screen including a second input region for inputting a character and a second display region for displaying the character input to the first input region when the pressing of the predetermined second button is detected;
displaying the character input to the first input region in the second display region by overwriting a character already displayed in the second display region with the character input to the first input region when the character is input to the first input region; and
displaying the character input to the second input region in the first display region by overwriting a character already displayed in the first display region with the character input to the second input region when the character is input to the second input region.

15. A non-transitory computer-readable recording medium having stored therein a program for causing a computer to execute a process, the process comprising:
switching, when pressing of a predetermined first button for calling a communication partner is detected on a predetermined screen of a first portable terminal for starting voice call, from the predetermined screen to a first screen including a first input region for inputting a character and a first display region for displaying a character input by the communication partner and displaying the first screen on the first portable terminal;
displaying, on a second portable terminal of the communication partner, an incoming call screen including a predetermined second button for answering a call from the first portable terminal when the pressing of the predetermined first button is detected;
switching the incoming call screen to a second screen including a second input region for inputting a character and a second display region for displaying the character input to the first input region when the pressing of the predetermined second button is detected;
erasing, when the character is input to the first input region, a character already displayed in the second display region and then displaying the character input to the first input region in the second display region; and
erasing, when the character is input to the second input region, a character already displayed in the first display region and then displaying the character input to the second input region in the first display region.

16. A character communication method executed by a computer to execute a process, the process comprising:
switching, when pressing of a predetermined first button for calling a communication partner is detected on a predetermined screen of a first portable terminal for starting voice call, from the predetermined screen to a first screen including a first input region for inputting a character and a first display region for displaying a character input by the communication partner and displaying the first screen on the first portable terminal;
displaying, on a second portable terminal of the communication partner, an incoming call screen including a predetermined second button for answering a call from the first portable terminal when the pressing of the predetermined first button is detected;
switching the incoming call screen to a second screen including a second input region for inputting a character and a second display region for displaying the character input to the first input region when the pressing of the predetermined second button is detected;
erasing, when the character is input to the first input region, a character already displayed in the second display region and then displaying the character input to the first input region in the second display region; and
erasing, when the character is input to the second input region, a character already displayed in the first display region and then displaying the character input to the second input region in the first display region.
